(19) United States
(12) Patent Application Publication
(10) Pub. No.: US 2026/0158472 A1
(43) Pub. Date: Jun. 11, 2026

(54) CATALYSTS FOR NITROGEN OXIDE REDUCTION AND ITS MANUFACTURING METHOD

(71) Applicant: University-Industry Cooperation Group of Kyung Hee University, Yongin-si (KR)

(72) Inventors: Jongsik KIM, Seongnam-si (KR); So Hyeon PARK, Suwon-si (KR)

(21) Appl. No.: 19/179,037

(22) Filed: Apr. 15, 2025

(30) Foreign Application Priority Data
May 29, 2024 (KR) 10-2024-0069798

(51) Int. Cl. B01J 23/34; B01J 35/61; B01J 35/63; B01J 37/04; B01J 37/12

(52) U.S. Cl. CPC B01J 23/34; B01J 35/613; B01J 35/633; B01J 37/04; B01J 37/12

(57) ABSTRACT

One embodiment provides a catalyst for nitrogen oxide reduction, including: catalytic sites including at least of manganese or cobalt vanadates represented by Formula 1 below; and a support on which the catalytic sites are supported; wherein a part of the catalytic sites is functionalized with H_{3-A}PO₄^{A-} (A=1, 2 or 3):

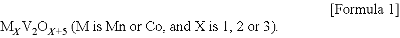

### CROSS REFERENCE TO RELATED APPLICATION

The present application claims priority to Korean Patent Application No. 10-2024-0069798, filed May 29, 2024, the entire contents of which are incorporated here for all purposes by this reference.

### BACKGROUND

### 1. Technical Field

The present disclosure relates to a manganese vanadate or cobalt vanadate catalyst for nitrogen oxide reduction functionalized with H_{3-A}PO₄^{A-} (A=1, 2 or 3). Specifically, the present disclosure relates to a solid catalyst for nitrogen oxide reduction including manganese vanadate or cobalt vanadate as catalytic sites in a support, wherein a part of the catalytic sites is modified with H_{3-A}PO₄^{A-} functional groups, and a method for synthesizing the same.

### 2. Related Art

Nitrogen oxides (NO_{X}), one of the main precursors of secondary particulate matter formation, is converted into N₂ and H₂O, which are harmless to the human body, by nitrogen oxide reduction reaction (selective catalytic NOX reduction (SCR); denitrification) according to reaction equations (1) and (2) below.

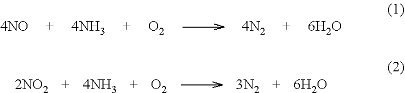

The operating efficiency of the SCR reaction is improved when the surface properties of the catalysts used are preferably controlled. For example, the properties of the catalyst surface may be improved by structurally modifying vanadium oxide that is applied as SCR catalytic sites.

Specifically, transition metal vanadate formed by chemical fusion of vanadium oxide and a transition metal oxide is preferred as catalytic sites for the SCR reaction. The transition metal vanadate is an oxide composed of vanadium-oxygen-transition metal channels in which vanadium and a transition metal are bonded via oxygen, and can overcome the limitations of existing vanadium oxide catalytic sites.

Metal vanadate can overcome one or more of the following disadvantages of vanadium oxide: 1) a small amount of Brønsted acid sites or Lewis acid sites; 2) poor redox cycling characteristics due to a small amount of redox sites (oxygen vacancies, mobile oxygen vacancies, labile oxygen vacancies); 3) the reduction in SCR operation efficiency per unit time due to weak interaction between NH₃ and acid sites, weak interaction between NO_{X}, and redox sites, and strong interaction between H₂O and acid sites (or redox sites); 4) poor durability against catalyst surface poisoning by the ammonium sulfate ((NH₄)₂SO₄, AS) and ammonium bisulfate ((NH₄)HSO₄, ABS), ABS) formed by a series of chemical reactions shown in reaction equations (3) to (5) below; 5) poor durability against catalyst surface poisoning by alkali metal-based compounds contained in exhaust gas; and 6) poor durability of the catalyst surface against hydrothermal aging.

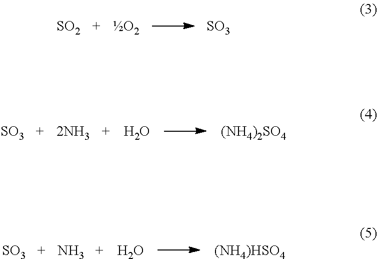

Specifically, when the transition metal vanadate (M is Mn or Co; X=1, 2 or 3) whose surface has been functionalized with H_{3-A}PO₄^{A-} (A=1 to 3) using the exhaust gas poison H₃PO₄ or a compound similar thereto is applied to the SCR reaction, it is possible to overcome one or more of the above-described limitations of vanadium oxide.

In a conventional art, lanthanides such as lanthanum (La), cerium (Ce), praseodymium (Pr), neodymium (Nd), samarium (Sm), europium (Eu), and gadolinium (Gd), which are not transition metals, are used. These lanthanides rare earth metals whose supply is low compared to demand, and may have problems in that they are difficult to obtain and have low utility due to technical difficulties in implementation.

Therefore, the present disclosure has achieved the advantages of high denitrification efficiency at low temperatures, easy availability, and mass synthesis, by introducing a transition metal vanadate using manganese (Mn) or cobalt (Co) that can replace rare earth metals used in conventional catalysts for nitrogen oxide reduction.

### SUMMARY

An object of the present disclosure is to realize the above-described advantages by applying manganese or cobalt vanadate as catalytic sites using a technique of functionalization with H_{3-A}PO₄^{A-} (A=1 to 3) in order to improve the operating efficiency of SCR reaction.

Another object of the present disclosure is to improve the SCR reaction performance and sustainability by functionalizing the surface of manganese or cobalt vanadate with H_{3-A}PO₄^{A-} (A=1, 2 or 3), and to provide a technique for synthesizing solid catalysts for SCR reaction including a crystal phase of at least one of manganese or cobalt vanadate as catalytic sites, and a technique for functionalization with H_{3-A}PO₄^{A-}.

Still another object of the present disclosure is to provide a method for synthesizing a solid catalyst for SCR reaction having improved acid properties, redox properties, and durability against poisoning and thermal aging by including an oxide of a Group 15 or Group 16 element as a promoter on the surface of a manganese or cobalt vanadate catalyst functionalized with H_{3-A}PO₄^{A-}.

Objects of the present disclosure are not limited to the objects mentioned above, and other technical objects not mentioned may be clearly understood by those skilled in the art to which the present disclosure pertains from the following description.

As a technical solution for achieving the above-mentioned objects, one aspect of the present disclosure provides a catalyst for nitrogen oxide reduction, including: catalytic sites including at least of manganese or cobalt vanadates represented by Formula 1 below; and a support on which the catalytic sites are supported, wherein a part of the catalytic sites is functionalized with H_{3-A}PO₄^{A-} (A=1, 2 or 3):

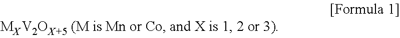

In one embodiment of the present disclosure, a promoter which is an oxide of a Group 15 or Group 16 element may be included in the support.

The promoter may be included in an amount ranging from 10⁻⁵ wt % to 50 wt % based on the weight of the support.

The Group 15 or Group 16 element may be at least one selected from the group consisting of nitrogen (N), phosphorus (P), sulfur (S), arsenic (As), selenium (Se), antimony (Sb), tellurium (Te), bismuth (Bi), polonium (Po), moscovium (Mc), livermorium (Lv), and combinations thereof.

The support may include at least one of carbon (C), Al₂O₃, MgO, ZrO₂, CeO₂, TiO₂, and SiO₂.

The manganese or cobalt vanadate represented by Formula 1 may be included in an amount ranging from 10⁻⁴ wt % to 50 wt % based on 100 parts by weight of the support.

The support may have a porous structure.

Another aspect of the present disclosure provides a method for synthesizing a catalyst for nitrogen oxide reduction, including steps of: mixing a vanadium precursor solution with a manganese or cobalt precursor solution; adding a material constituting a support to the mixed solution; collecting a solid from the mixed solution and calcining the solid, thereby synthesizing a catalyst in which at least one of manganese or cobalt vanadates represented by Formula 1 below is supported as catalytic sites on the support; and functionalizing a part of the surface of the synthesized catalyst with H_{3-A}PO₄^{A-} (A=1, 2 or 3):

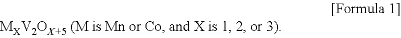

In one embodiment of the present disclosure, the step of functionalizing with H_{3-A}PO₄^{A-} includes a step of stirring the catalyst in a synthetic solvent, followed by drying, wherein the synthetic solvent may contain an organic phosphoric acid compound which is at least one of phosphoric acid (H₃PO₄), ammonium phosphite (NH₄)₃PO₄), ammonium monohydrogen phosphite (NH₄)₂HPO₄), ammonium dihydrogen phosphate (NH₄H₂PO₄), dimethyl phosphite ((CH₃O)₂HPO), diethyl phosphite ((C₂H₅O)₂HPO), trimethyl phosphite ((CH₃O)₃P), triethyl phosphite ((C₂H₅O)₃P), triisopropyl phosphite ((C₃H₇)₃P), and triphenyl phosphite ((C₆H₅O)₃P).

The concentration of the organic phosphoric acid compound in the synthetic solvent may range from 10⁻⁵ mol L⁻¹ to 10⁵ mol L⁻¹.

The step of stirring may be performed for 0.1 hours to 24 hours.

The step of functionalizing with H_{3-A}PO₄^{A-} may be performed using a reactive gas containing oxygen (O₂).

The concentration of oxygen (O₂) in the reactive gas may range from 10 ppm to 10⁶ ppm.

The step of functionalizing with H_{3-A}PO₄^{A-} may be performed in a temperature range of 100° C. to 800° C. for 0.1 to 24 hours under conditions of a flow rate of 10⁻⁵ mL min⁻¹ to 10⁵ mL min⁻¹ and a pressure of 10⁻⁵ bar to 10⁵ bar.

According to one embodiment of the present disclosure, it is possible to synthesize a catalyst having at least one metal vanadate containing manganese or cobalt dispersed on the surface thereof, and to realize a catalyst surface showing a high NO_{X}, conversion and high N₂ selectivity during SCR operation by applying an oxide of a Group 15 or Group 16 element as a promoter or functionalizing a part of the catalytic sites with H_{3-A}PO₄^{A-}.

According to one embodiment of the present disclosure, functionalization of manganese (Mn) vanadate or cobalt (Co) vanadate with H_{3-A}PO₄^{A-} may be more effective in increasing the number of Brønsted acid sites for NH₃ adsorption or in enhancing the redox properties of the catalyst surface than functionalization of nickel (Ni) vanadate with H_{3-A}PO₄^{A-} according to a conventional art.

According to one embodiment of the present disclosure, based on functionalization of the catalyst surface with H_{3-A}PO₄^{A-}, 1) desirable interactions between acid sites or redox sites in the catalytic sites and NO_{X}, NH₃, O₂, and H₂O may be induced, and 2) the durability of the catalyst against poisoning and thermal aging occurring during the SCR reaction may be enhanced, so that the high SCR performance and long life of the catalyst may be realized.

According to one embodiment of the present disclosure, it is possible to realize the advantages of high denitrification efficiency at low temperatures, easy availability, and mass synthesis, by introducing a transition metal vanadate using manganese (Mn) or cobalt (Co) that can replace rare earth metals used in conventional catalysts for nitrogen oxide reduction.

The effects of the present disclosure are not limited to the above-described effects, and should be understood to include all effects that can be inferred from the configuration of the present disclosure described in the description or claims of the present disclosure.

### BRIEF DESCRIPTION OF THE DRAWINGS

FIG. 1 shows high-resolution transmission electron microscopy (HRTEM) images of Comparative Examples 1 to 4 of the present disclosure.

FIG. 2 is a photograph showing selected-area electron diffraction (SAED) patterns of Comparative Examples 1 to 4 of the present disclosure.

FIG. 3 shows high-resolution transmission electron microscopy (HRTEM) images of Examples 1 to 3 of the present disclosure.

FIG. 4 is a photograph showing selected-area electron diffraction (SAED) patterns of Examples 1 to 4 of the present disclosure.

FIG. 5 shows high-resolution transmission electron microscopy (HRTEM) images of Examples 4 to 6 of the present disclosure.

FIG. 6 is a photograph showing selected-area electron diffraction (SAED) patterns of Examples 4 to 6 of the present disclosure.

FIG. 7 shows high-resolution transmission electron microscopy (HRTEM) images of Examples 7 to 9 of the present disclosure.

FIG. 8 is a photograph showing selected-area electron diffraction (SAED) patterns of Examples 7 to 9 of the present disclosure.

FIG. 9 is a photograph showing selected-area electron diffraction (SAED) patterns of Examples 10 and 11 of the present disclosure.

FIG. 10 is a photograph showing selected-area electron diffraction (SAED) patterns of Examples 10 and 11 of the present disclosure.

FIGS. 11 to 17 are graphs showing NO_{X} conversion by catalysts, synthesized according to the Comparative Examples and Examples of the present disclosure, under various SCR conditions.

### DETAILED DESCRIPTION

Hereinafter, the present disclosure will be described in more detail. However, the present disclosure may be embodied in various different forms and is not limited to the embodiments described herein, and the present disclosure is defined only by the appended claims.

Hereinafter, the present disclosure will be described with reference to the accompanying drawings. However, the present disclosure may be embodied in various different forms, and thus is not limited to the embodiments described herein. In addition, in order to clearly describe the present disclosure in the drawings, the parts unrelated to the description are omitted, and like reference numerals are used to indicate like parts throughout the specification.

Throughout the present specification, when any part is referred to as being “connected”, “contacted”, or “coupled” to another part, it not only refers to a case where the part “connected directly” to the other part, but also a case where the part is connected indirectly to the other part with a third member interposed therebetween. In addition, it is to be understood that when any part is referred to as “including” any component, it does not exclude other components, but may further include other components, unless otherwise specified.

The terms used herein are only to describe specific embodiments and are not intended to limit the scope of the present disclosure. Singular expressions include plural expressions unless otherwise specified in the context thereof. In the present specification, it should be understood that terms such as “include(s)” or “have (has)”, etc. are intended to specify the presence of the stated feature, number, step, operation, element, part, or combinations thereof, but do not preclude the possibility of presence or addition of one or more other features, numbers, steps, operations, elements, parts, or combinations thereof.

A first aspect of the present disclosure provides a catalyst for nitrogen oxide reduction, including: catalytic sites including at least of manganese or cobalt vanadates represented by Formula 1 below; and a support on which the catalytic sites are supported, wherein a part of the catalytic sites is functionalized with H_{3-A}PO₄^{A-} (A=1, 2 or 3):

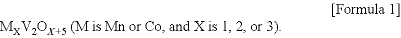

Hereinafter, the catalyst for nitrogen oxides reduction according to the first aspect of the present disclosure will be described in detail.

In one embodiment of the present disclosure, a promoter which is an oxide of a Group 15 or Group 16 element may be included in the support.

In one embodiment of the present disclosure, the promoter may be included in an amount ranging from 10⁻⁵ wt % to 50 wt % based on the weight of the support.

In one embodiment of the present disclosure, the Group 15 or Group 16 element may be at least one selected from the group consisting of nitrogen (N), phosphorus (P), sulfur (S), arsenic (As), selenium (Se), antimony (Sb), tellurium (Te), bismuth (Bi), polonium (Po), moscovium (Mc), livermorium (Lv), and combinations thereof.

In one embodiment of the present disclosure, the support may include at least one of carbon (C), Al₂O₃, MgO, ZrO₂, CeO₂, TiO₂, and SiO₂.

In one embodiment of the present disclosure, the manganese or cobalt vanadate represented by Formula 1 may be included in an amount ranging from 10⁻⁴ wt % to 50 wt % based on 100 parts by weight of the support.

In one embodiment of the present disclosure, the support may have a porous structure.

In one specific embodiment of the present disclosure, the catalytic sites may consist of a vanadate composed of Mn, V and O, and have an MN molar ratio of 0.5 to 1.5, and a P/(Sb+M+V) molar ratio of 10⁻² to 1.0. Preferably, the catalytic sites may consist of one of MnV₂O₆, Mn₂V₂O₇, and Mn₃V₂O₈. M may preferably be a transition metal or a rare earth metal, more preferably a transition metal, even more preferably Mn.

In one specific embodiment of the present disclosure, the catalytic sites may consist of a vanadate composed of Co, V and O, and have an M/V molar ratio of 0.5 to 1.5, and a P/(Sb+M+V) molar ratio of 10⁻² to 1.0. Preferably, the catalytic sites may consist of one of CoV₂O₆, Co₂V₂O₇ and Co₃V₂O₈. M may preferably be a transition metal or a rare earth metal, more preferably a transition metal, even more preferably Co.

A second aspect of the present disclosure provides a method for synthesizing a catalyst for nitrogen oxide reduction, including steps of: mixing a vanadium precursor solution with a manganese or cobalt precursor solution; adding a material constituting a support to the mixed solution; collecting a solid from the mixed solution and calcining the solid, thereby synthesizing a catalyst in which at least one of manganese or cobalt vanadates represented by Formula 1 below is supported as catalytic sites on the support; and functionalizing a part of the surface of the synthesized catalyst with H_{3-A}PO₄^{A-} (A=1, 2 or 3):

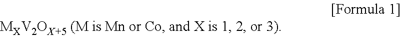

Detailed description of parts overlapping with those in the first aspect of the present disclosure is omitted, but the contents described with respect to the first aspect of the present disclosure may be equally applied even if the description thereof for the second aspect is omitted.

Hereinafter, the method for synthesizing a catalyst for nitrogen oxides reduction according to the second aspect of the present disclosure will be described in detail.

In one embodiment of the present disclosure, the step of functionalizing with H_{3-A}PO₄^{A-} includes a step of stirring the catalyst in a synthetic solvent, followed by drying, wherein the synthetic solvent may contain an organic phosphoric acid compound which is at least one of phosphoric acid (H₃PO₄), ammonium phosphite (NH₄)₃PO₄), ammonium monohydrogen phosphite (NH₄)₂HPO₄), ammonium dihydrogen phosphate (NH₄H₂PO₄), dimethyl phosphite ((CH₃O)₂HPO), diethyl phosphite ((C₂H₅O)₂HPO), trimethyl phosphite ((CH₃O)₃P), triethyl phosphite ((C₂H₅O)₃P), triisopropyl phosphite ((C₃H₇)₃P), and triphenyl phosphite ((C₆H₅O)₃P).

In one embodiment of the present disclosure, the concentration of the organic phosphoric acid compound in the synthetic solvent may range from 10⁻⁵ mol L⁻¹ to 10⁵ mol L⁻¹.

In one embodiment of the present disclosure, the step of stirring may be performed for 0.1 hours to 24 hours.

In one embodiment of the present disclosure, the step of functionalizing with H_{3-A}PO₄^{A-} may be performed using a reactive gas containing oxygen (O₂).

In one embodiment of the present disclosure, the concentration of oxygen (O₂) in the reactive gas may range from 10 ppm to 10⁶ ppm.

In one embodiment of the present disclosure, the step of functionalizing with H_{3-A}PO₄^{A-} may be performed in a temperature range of 100° C. to 800° C. for 0.1 to 24 hours under conditions of a flow rate of 10⁻⁵ mL min⁻¹ to 10⁵ mL min⁻¹ and a pressure of 10⁻⁵ bar to 10⁵ bar.

Hereinafter, examples of the present disclosure will be described in detail so that those skilled in the art can easily carry out the present disclosure. However, the present disclosure may be embodied in various different forms and is not limited to the examples described herein.

### Comparative Examples 1 to 4: Synthesis of Ni₁-P500, Ni₂-P500, Ni₃-P500 and Ni₁—Sb-P500 Catalysts

A solution of ‘B’ mmol of a nickel precursor (Ni(NO₃)₂*6H₂O) (B was 0.98 mmol for Ni₁, 1.96 mmol for Ni₂, and 2.94 mmol for Ni₃) in 60 mL of distilled water was added to a solution of 1.96 mmol of NH₄VO₃ in 140 mL of distilled water, and the mixture was stirred at room temperature for 30 minutes. Then, ‘C’ g of an anatase (TiO₂) support (C was 4.84 g for Ni₁, 4.78 g for Ni₂, and 4.73 g for Ni₃) was added thereto, and the mixture was stirred at room temperature for 4 hours. The formed mixed solution was dehydrated, dried, and then calcined at 500° C. for 5 hours, thereby producing catalysts, which were named Ni₁, Ni₂, and Ni₃, respectively. Meanwhile, 100 mL of a solution of 12.32 mmol of Sb(CH₃COO)₃ in acetic acid was added to 250 mL of distilled water containing 48.5 g of TiO₂, and the mixture was stirred, dehydrated, and then calcined at 500° C. for 5 hours, thereby preparing a TiO₂ support (Sb/TiO₂) loaded with 3 wt % of Sb. A catalyst was produced using Sb/TiO₂ under the same conditions as the synthesis conditions for Ni₁, and was named Ni₁-Sb. 3 g of Ni₁, Ni₂, Ni₃ or Ni₁—Sb was added to a solution of 0.44 mmol of (NH₄)₂HPO₄ in 250 mL of distilled water, and the mixture was stirred at room temperature for 18 hours. The formed mixture solution was dehydrated, dried, and then calcined at 500° C. for 1 hour, thereby synthesizing Ni₁—P (Comparative Example 1), Ni₂—P (Comparative Example 2), Ni₃—P (Comparative Example 3), or Ni₁—Sb—P (Comparative Example 4).

### Examples 1 to 3: Synthesis of Mn₁-P500, Mn₂-P500 and Mn₃-P500 Catalysts

A solution of ‘D’ mmol of a manganese precursor (Mn(NO₃)₂*XH₂O) (D was 0.98 mmol for Mn₁, 1.96 mmol for Mn₂, and 2.94 mmol for Mn₃) in 60 mL of distilled water was added to a solution of 1.96 mmol of NH₄VO₃ in 140 mL of distilled water, and the mixture was stirred at room temperature for 30 minutes. Then, ‘E’ g of an anatase (TiO₂) support (E was 4.85 g for Mn₁, 4.79 g for Mn₂, and 4.74 g for Mn3) was added thereto, and the mixture was stirred at room temperature for 4 hours. The formed mixed solution was dehydrated, dried, and then calcined at 500° C. for 5 hours, thereby producing catalysts, which were named Mn₁, Mn₂, and Mn₃, respectively. 3 g of Mn₁, Mn₂, or Mn₃ was added to a solution of 0.44 mmol of (NH₄)₂HPO₄ in 250 mL of distilled water, and the mixture was stirred at room temperature for 18 hours. The formed mixture solution was dehydrated, dried, and then calcined at 500° C. for 1 hour, thereby synthesizing Mn₁—P (Example 1), Mn₂—P (Example 2), or Mn₃—P (Example 3).

### Examples 4 to 6: Synthesis of Mn₁—Sb-P300, Mn₁—Sb-P400 and Mn₁-Sb-P500 Catalysts

A catalyst was produced using Sb/TiO₂ under the same conditions as the synthesis conditions for Mn₁, and was named Mn₁—Sb. 3 g of Mn1-Sb was added to a solution of 0.44 mmol of (NH₄)₂HPO₄ in 250 mL of distilled water, and the mixture was stirred at room temperature for 18 hours. The formed mixture solution was dehydrated, dried, and then calcined at 300° C., 400° C., or 500° C. for 1 hour, thereby synthesizing Mn₁—Sb—P300 (Example 4), Mn₁—Sb-P400 (Example 5), or Mn₁—Sb-P500 (Example 6).

### Examples 7 to 9: Synthesis of Co₁—Sb-P500, Co₂—Sb-P500 and Co₃—Sb-P500 Catalysts

A solution of ‘F’ mmol of a cobalt precursor (Co(NO₃)₂*XH₂O) (F was 0.98 mmol for Co₁—Sb, 1.96 mmol for Co₂—Sb, and 2.94 mmol for Co₃—Sb) in 60 mL of distilled water was added to a solution of 1.96 mmol of NH₄VO₃ in 140 mL of distilled water, and the mixture was stirred at room temperature for 30 minutes. Then, ‘G’ g of a Sb/TiO₂ support (G was 4.84 g for Co₁—Sb, 4.78 g for Co₂—Sb, and 4.73 g for Co₃—Sb) was added thereto, and the mixture was stirred at room temperature for 4 hours. The formed mixed solution was dehydrated, dried, and then calcined at 500° C. for 5 hours, thereby producing catalysts, which were named Co₁—Sb, Co₂—Sb, and Co₃—Sb, respectively. 3 g of Co₁—Sb, Co₂—Sb, or Co₃—Sb was added to a solution of 0.44 mmol of (NH₄)₂HPO₄ in 250 mL of distilled water, and the mixture was stirred at room temperature for 18 hours. The formed mixture solution was dehydrated, dried, and then calcined at 500° C. for 1 hour, thereby synthesizing Co₁—Sb-P500 (Example 7), Co₂—Sb-P500 (Example 8), or Co₃—Sb-P500 (Example 9).

### Examples 10 and 11: Synthesis of Co₁—Sb-P300 and Co₁—Sb-P400 Catalysts

3 g of Co₁—Sb was added to a solution of (NH₄)₂HPO₄ in 250 mL of distilled water, and the mixture was stirred at room temperature for 18 hours. The formed mixture solution was dehydrated, dried, and then calcined at 300° C. or 400° C. for 1 hour, thereby synthesizing Co₁—Sb-P300 (Example 10) or Co¹—Sb-P400 (Example 11).

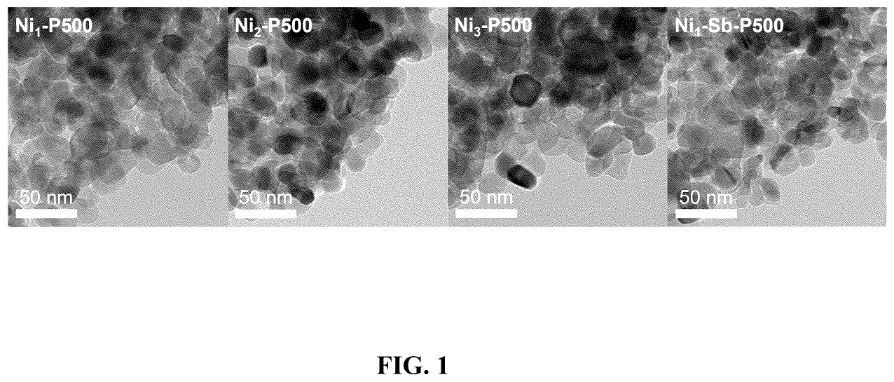

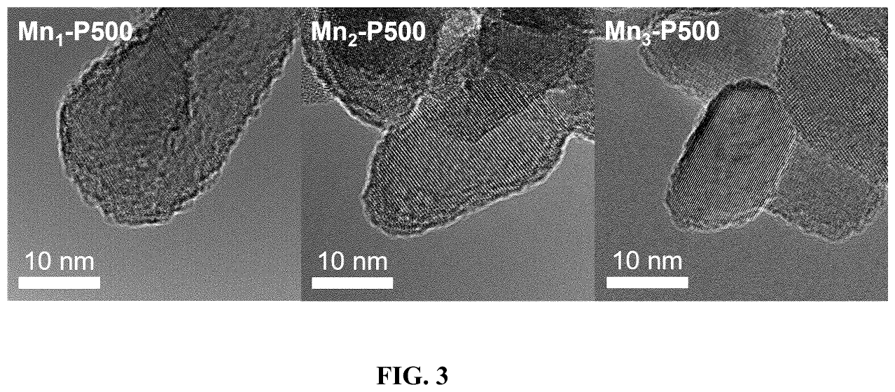

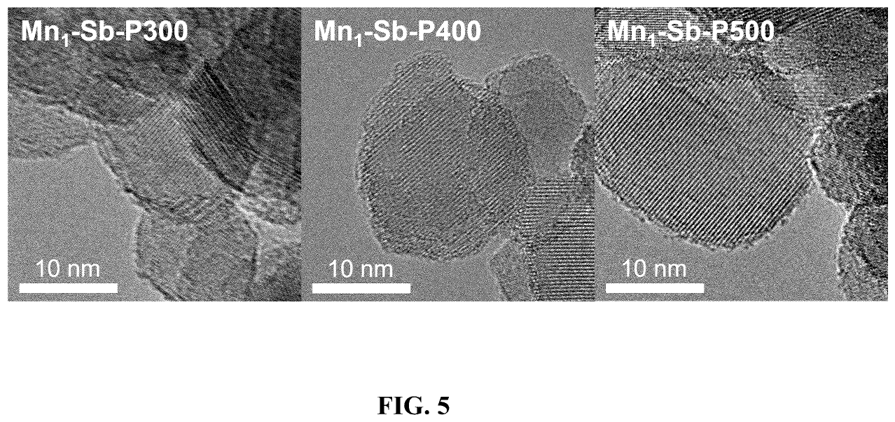

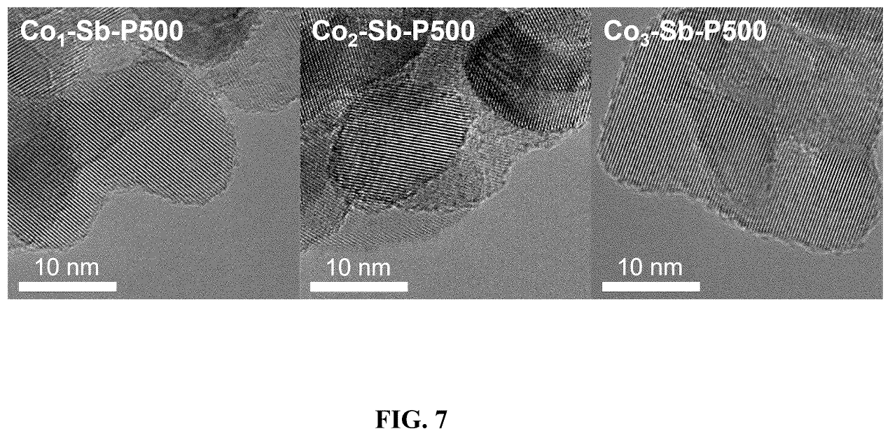

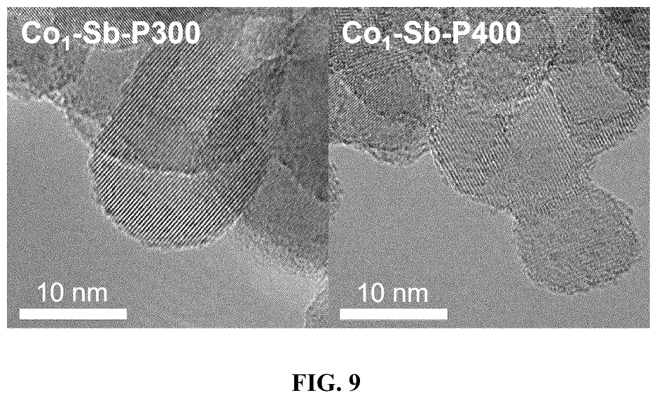

The morphologies of the catalysts synthesized in Comparative Examples 1 to 4 and Examples 1 to 11 were analyzed using high-resolution transmission electron microscopy (HRTEM), and the results are shown in FIGS. 1, 3, 5, 7, and 9. Referring to these figures, it can be seen that TiO₂ aggregates having a size of tens to hundreds of nanometers in the synthesized catalysts exhibit porous characteristics. In order to examine the porosities of the catalysts synthesized in Comparative Examples 1 to 4 and Examples 1 to 11, N₂ physisorption experiments were conducted, the BET specific surface areas and BJH pore volumes were analyzed, and the results are presented in Table 1 below. In addition, the components of the catalysts were analyzed using inductively coupled plasma spectroscopy, and the results are presented in Table 1 below.

TABLE 1

| | BET specific | BJH pore | | |
|---|---|---|---|---|
| | surface area | volume | | P/(Sb + |
| Catalyst | (m² g⁻¹) | (cm³ g⁻¹) | M/V ¹ | M + V) ¹ |
| Comparative | 71.0 | 0.3 | 0.4 (±0.1) | 0.2 (±0.1) |
| Example 1 | | | | |
| Comparative | 71.3 | 0.3 | 0.9 (±0.1) | 0.2 (±0.1) |
| Example 2 | | | | |
| Comparative | 74.1 | 0.3 | 1.5 (±0.1) | 0.2 (±0.1) |
| Example 3 | | | | |
| Comparative | 82.0 | 0.3 | 0.5 (±0.1) | 0.2 (±0.1) |
| Example 4 | | | | |
| Example 1 | 76.5 | 0.3 | 0.5 (±0.1) | 0.2 (±0.1) |
| Example 2 | 74.9 | 0.3 | 1.0 (±0.1) | 0.2 (±0.1) |
| Example 3 | 74.9 | 0.3 | 1.4 (±0.1) | 0.2 (±0.1) |
| Example 4 | 65.4 | 0.3 | 0.4 (±0.1) | 0.2 (±0.1) |
| Example 5 | 66.7 | 0.3 | 0.4 (±0.1) | 0.2 (±0.1) |
| Example 6 | 66.4 | 0.3 | 0.4 (±0.1) | 0.2 (±0.1) |
| Example 7 | 82.1 | 0.3 | 0.5 (±0.1) | 0.2 (±0.1) |
| Example 8 | 80.8 | 0.3 | 0.9 (±0.1) | 0.2 (±0.1) |
| Example 9 | 82.1 | 0.3 | 1.4 (±0.1) | 0.2 (±0.1) |
| Example 10 | 80.8 | 0.3 | 0.5 (±0.1) | 0.2 (±0.1) |
| Example 11 | 80.9 | 0.3 | 0.5 (±0.1) | 0.2 (±0.1) |

¹ M is manganese (Mn) or cobalt (Co).

From the results of analyzing the BET specific surface areas and BJH pore volumes, it could be confirmed that the catalysts of Comparative Examples 1 to 4 and Examples 1 to 11 had a porous structure. In addition, the V contents of the catalysts were almost the same at 2 wt % based on the total weight of the catalyst. In addition, it could be confirmed that the M/V molar ratios of the catalysts of the Comparative Examples and the Examples had values close to the M/V molar ratio of the vanadate present in the catalysts. Specifically, the M/V values of the catalysts of Comparative Examples 1 and 4 are close to the theoretical Ni/V value of NiV₂O₆, which is 0.5, the MN value of the catalyst of Comparative Example 2 is close to the theoretical Ni/V value of Ni₂V₂O₇, which is 1.0, and the MN value of the catalyst of Comparative Example 3 is close to the theoretical Ni/V value of Ni₃V₂O₈, which is 1.5. In addition, specifically, the MN values of the catalysts of Examples 1, 4, 5, and 6 are close to the theoretical Mn/V value of MnV₂O₆, which is 0.5, the MN value of the catalyst of Example 2 is close to the theoretical Mn/V value of Mn₂V₂O₇, which is 1.0, and the MN value of the catalyst of Example 3 is close to the theoretical Mn/V value of Mn₃V₂O₈, which is 1.5. In addition, specifically, the MN values of the catalysts of Examples 7, 10, and 11 are close to the theoretical Co/V value of CoV₂O₆, which is 0.5, the MN value of the catalyst of Example 8 is close to the theoretical Co/V value of Co₂V₂O₇, which is 1.0, and the MN value of the catalyst of Example 9 is close to the theoretical Co/V value of Co₃V₂O₈, which is 1.5.

Based on these results, it could be seen that NiV₂O₆ was successfully dispersed on the porous TiO₂ surface of the catalysts of Comparative Examples 1 and 4, Ni₂V₂O₇ was successfully dispersed on the porous TiO₂ surface of the catalyst of Comparative Example 2, and Ni₃V₂O₈ was successfully dispersed on the porous TiO₂ surface of the catalyst of Comparative Example 3. Also, based on these results, it could be seen that MnV₂O₆ was successfully dispersed on the porous TiO₂ surface of the catalysts of Examples 1, 4, 5 and 6, Mn₂V₂O₇ was successfully dispersed on the porous TiO₂ surface of the catalyst of Example 2, and Mn₃V₂O₈ was successfully dispersed on the porous TiO₂ surface of the catalyst of Example 3. In addition, based on these results, it could be seen that CoV₂O₆ was successfully dispersed on the porous TiO₂ surface of the catalysts of Examples 7, 10 and 11, Co₂V₂O₇ was successfully dispersed on the porous TiO₂ surface of the catalyst of Example 8, and Co₃V₂O was successfully dispersed on the porous TiO₂ surface of the catalyst of Example 9.

In addition, it could be seen that the P/(Sb+M+V) molar ratios of the catalysts, synthesized in Comparative Examples 1 to 4 and Examples 1 to 11 and functionalized with H_{3-A}PO₄^{A-}, had the same value of 0.2. This means that the degree of functionalization with H_{3-A}PO₄^{A-} was similar between the catalysts synthesized in Comparative Examples 1 to 4 and Examples 1 to 11.

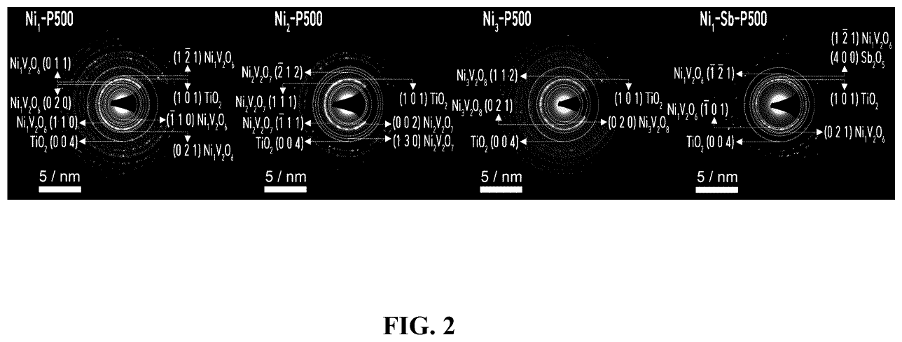

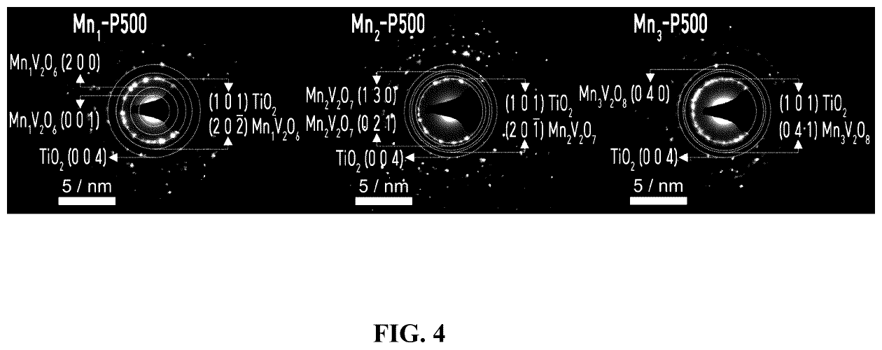

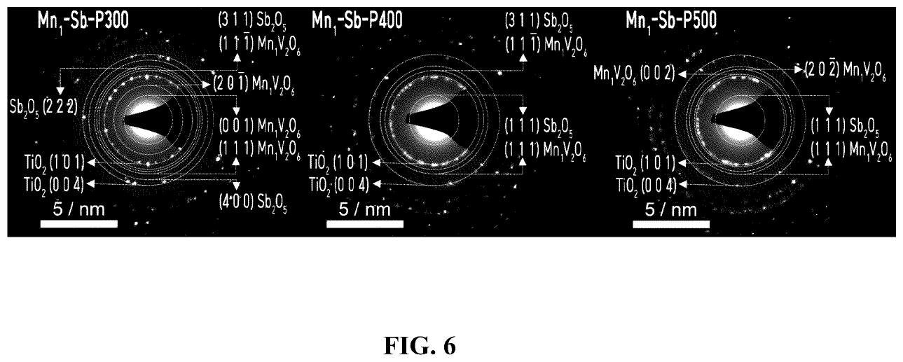

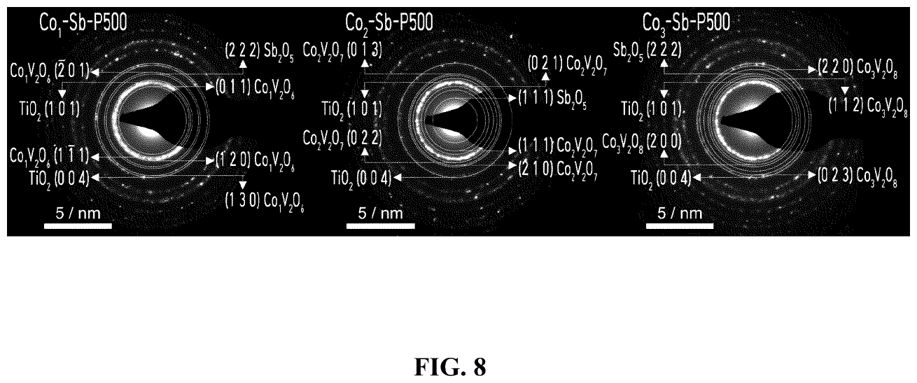

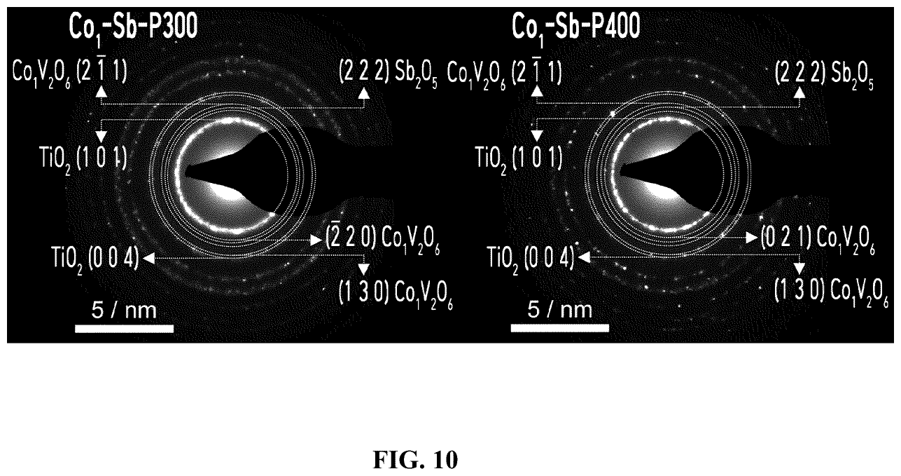

The crystal structures of the catalysts synthesized in Comparative Examples 1 to 4 and Examples 1 to 11 were analyzed using the selected-area electron diffraction (SAED) patterns, and the results are shown in FIGS. 2, 4, 6, 8, and 10. The SAED patterns of all the synthesized catalysts include the crystal planes of tetragonal TiO₂, which is due to the TiO₂ support present in the catalysts. In addition, the SAED patterns of the catalysts of Comparative Example 4 and Examples 4 to 11 include crystal planes of cubic Sb₂O₅, which is due to the Sb₂O₅ present in the catalysts. Referring to the SAED patterns in FIG. 2, the catalysts of Comparative Examples 1 and 4 include the crystal plane of triclinic NiV₂O₆, the catalyst of Comparative Example 2 includes the crystal plane of monoclinic Ni₂V₂O₇, and the catalyst of Comparative Example 3 includes the crystal plane of orthorhombic Ni₃V₂Os. Referring to the SAED patterns in FIGS. 4 and 6, the catalysts of Examples 1 and 4 to 6 include the crystal plane of monoclinic MnV₂O₆, the catalyst of Example 2 includes the crystal plane of monoclinic Mn₂V₂O₇, and the catalyst of Example 3 includes a crystal plane of orthorhombic Mn₃V₂Os. Referring to the SAED patterns in FIGS. 8 and 10, the catalysts of Examples 7 and 10 to 11 include the crystal plane of triclinic CoV₂O₆, the catalyst of Example 8 includes the crystal plane of monoclinic Co₂V₂O₇, and the catalyst of Example 9 includes the crystal plane of orthorhombic Co₃V₂O₈.

As shown in FIGS. 2, 4, 6, 8, and 10, SAED patterns of materials other than manganese vanadate or cobalt vanadate, such as vanadium oxide, manganese oxide, or cobalt oxide, were not observed in the SAED of the catalysts synthesized in Comparative Examples 1 to 4 and Examples 1 to 11. That is, it could be seen that the catalysts synthesized in Comparative Examples 1 to 4 and Examples 1 to 11 of the present disclosure contained only manganese vanadate (or cobalt vanadate), which is an oxide in which vanadium oxide and manganese oxide (or cobalt oxide) are fused into one, and did not separately contain vanadium oxide and manganese oxide (or cobalt oxide) separately.

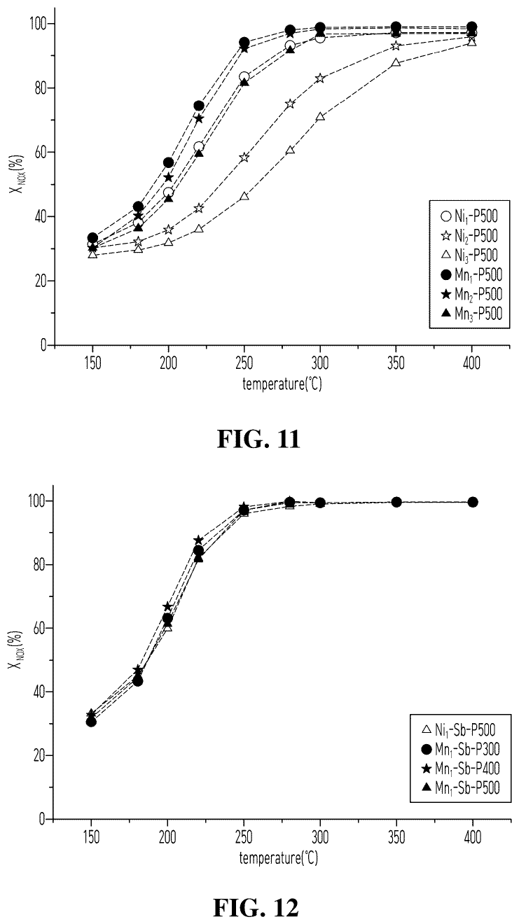

Hereinafter, the SCR reaction performance of the catalysts synthesized in Comparative Examples 1 to 4 and Examples 1 to 11 will be described with reference to FIGS. 11 to 17.

### Experimental Example 1: Analysis I of SCR Reaction Performance

The SCR reaction performance of the catalysts of Comparative Examples 1 to 3 functionalized with H_{3-A}PO₄^{A-} and the catalyst of Examples 1 to 3 functionalized with H_{3-A}PO₄^{A-} was measured in the absence of SO₂. Specifically, the performance of the above-described catalysts was measured in the presence of a reactive fluid containing 800 ppm NO_{X}, 800 ppm NH₃, 3 vol % O₂, 6 vol % H₂O, and the inert gas N₂ at a space velocity of 60,000 hr⁻¹, and the results of measuring the nitrogen oxide conversion (NO_{X} conversion, X_{NOX}) are shown in FIG. 11. All the catalysts exhibited 100% N₂ selectivity in the temperature range of 150° C. to 400° C. Referring to FIG. 11, it can be seen that, at a temperature of 150° C. to 400° C., the X_{NOX} values were higher in MnV₂O₆ of Example 1 than in NiV₂O₆ of Comparative Example 1, higher in Mn₂V₂O₇ of Example 2 than in Ni₂V₂O₇ of Comparative Example 2, and higher in Mn₃V₂O₈ of Example 3 than in Ni₃V₂O₈ of Comparative Example 3.

This means that the functionalization of manganese vanadate with H_{3-A}PO₄^{A-} is more effective in increasing the number of Brønsted acid sites for NH₃ adsorption or in enhancing the redox properties of the catalyst surface than the functionalization of nickel vanadate with H_{3-A}PO₄^{A-}. In addition, it can be seen that, among the catalysts of Examples 1 to 3 containing manganese vanadate (Mn_{X}V₂O_{X+5}), the catalyst of Example 2 (X=2) showed a higher X_{NOX} value than the catalyst of Example 3 (X=3) at 150° C. to 400° C., and the catalyst of Example 1 (X=1) showed a higher X_{NOX} value than the catalyst of Example 2 (X=2) at 150° C. to 400° C. This means that the MnV₂O₆ crystal phase (structure) of Example 1 (X=1) is most effective in increasing the number of Brønsted acid sites for NH₃ adsorption induced by the H_{3-A}PO₄^{A-} functional groups present on the surface of manganese vanadate and in enhancing the redox properties of the catalyst surface.

### Experimental Example 2: Analysis II of SCR Reaction Performance

The SCR reaction performance of the catalysts of Comparative Example 4 and Examples 4 to 6 functionalized with H_{3-A}PO₄^{A-} and containing the Sb₂O₅ promoter was measured in the absence of SO₂. Specifically, the performance of the above-described catalysts was measured in the presence of a reactive fluid containing 800 ppm NO_{X}, 800 ppm NH₃, 3 vol % O₂, 6 vol % H₂O, and the inert gas N₂ at a space velocity of 60,000 hr⁻¹, and the results of measuring the nitrogen oxide conversion (NO_{X} conversion, X_{NOX}) are shown in FIG. 12. All the catalysts exhibited 100% N₂ selectivity in the temperature range of 150° C. to 400° C. Referring to FIG. 12, it can be seen that the catalysts of Examples 1 to 3 containing manganese vanadate (MnV₁O₆) functionalized with H_{3-A}PO₄^{A-} at 300° C. to 500° C. exhibited similar or higher X_{NOX} values at 250° C. or below compared to the catalyst of Comparative Example 4 containing NiV₂O₆ functionalized with H_{3-A}PO₄^{A-}. This means that the H_{3-A}PO₄^{A-}-functionalized manganese vanadate-based catalyst surface is more effective in increasing the number of Brønsted acid sites or enhancing the redox properties of the catalyst surface compared to the H_{3-A}PO₄^{A-} functionalized nickel vanadate-based catalyst surface. In addition, it can be seen that, among the catalysts of Examples 1 to 3, the catalyst of Example 2 exhibited the highest X_{NOX} value at 250° C. or below. This means that it is important to preferably control and select conditions for functionalization with H_{3-A}PO₄^{A-}, such as the concentration of the H_{3-A}PO₄^{A-} precursor ((NH₄)₂HPO₄) and the calcination temperature and time of the precursor on the catalyst surface, in order to realize the desirable properties of the manganese vanadate-based catalyst surface functionalized with H_{3-A}PO₄^{A-}.

### Experimental Example 3: Analysis III of SCR Reaction Performance

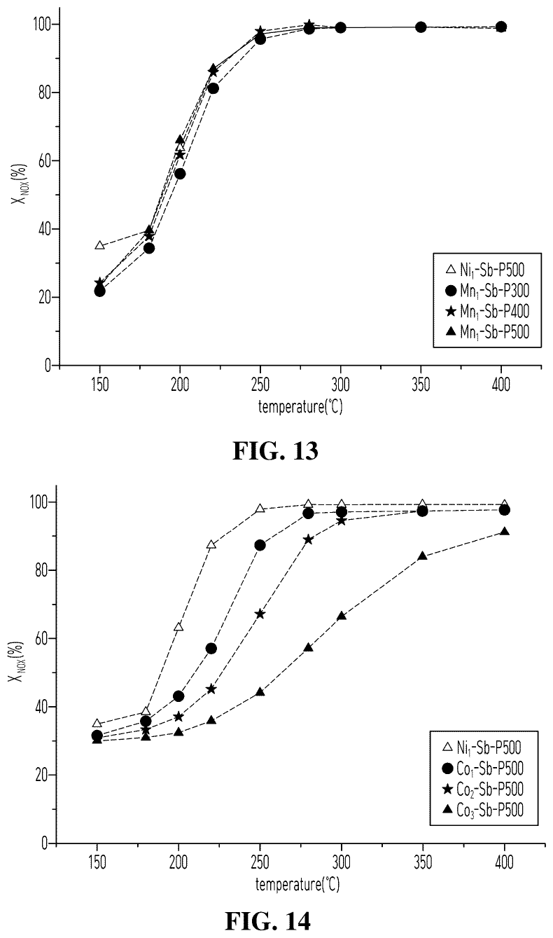

The SCR reaction performance of the catalysts of Comparative Example 4 and Examples 4 to 6 functionalized with H_{3-A}PO₄^{A-} and containing the Sb₂O₅ promoter was measured in the absence of SO₂. Specifically, the performance of the above-described catalysts was measured in the presence of a reactive fluid containing 800 ppm NO_{X}, 800 ppm NH₃, 3 vol % O₂, 6 vol % H₂O, and the inert gas N₂ at a space velocity of 60,000 hr⁻¹, and the results of measuring the nitrogen oxide conversion (NO_{X} conversion, X_{NOX}) are shown in FIG. 13. All the catalysts exhibited 100% N₂ selectivity in the temperature range of 150° C. to 400° C. Referring to FIG. 13, it can be seen that the catalysts of Examples 2 to 3 of the present disclosure, which contain manganese vanadate (MnV₁O₆) functionalized with H_{3-A}PO₄^{A-} at 400° C. to 500° C., exhibited similar X_{NOX} values at 150° C. to 400° C. compared to the catalyst of Comparative Example 4, which contains NiV₂O₆ functionalized with H_{3-A}PO₄^{A-}. In addition, it can be seen that, among the catalysts of Examples 1 to 3, the catalyst of Example 1 shows the smallest X_{NOX} value at 250° C. or below. This means that it is important to preferably control and select conditions for functionalization with H_{3-A}PO₄^{A-}, such as the concentration of the H_{3-A}PO₄^{A-} precursor ((NH₄)₂HPO₄) and the calcination temperature and time of the precursor on the catalyst surface, in order to realize the desirable SO₂ resistance of the manganese vanadate-based catalyst surface functionalized with H_{3-A}PO₄^{A-}.

### Experimental Example 4: Analysis IV of SCR Reaction Performance

The SCR reaction performance of the catalysts of Comparative Example 4 and Examples 7 to 9 functionalized with H_{3-A}PO₄^{A-} and containing the Sb₂O₅ promoter was measured in the absence of SO₂. Specifically, the performance of the above-described catalysts was measured in the presence of a reactive fluid containing 800 ppm NO_{X}, 800 ppm NH₃, 3 vol % O₂, 6 vol % H₂O, and the inert gas N₂ at a space velocity of 60,000 hr⁻¹, and the results of measuring the nitrogen oxide conversion (NO_{X} conversion, X_{NOX}) are shown in FIG. 14. All the catalysts exhibited 100% N₂ selectivity in the temperature range of 150° C. to 400° C. Referring to FIG. 14, it can be seen that the catalysts of Examples 7 to 9 of the present disclosure, which contain cobalt vanadate (Co_{X}V₂O_{X+5}) functionalized with H_{3-A}PO₄^{A-} exhibited smaller X_{NOX} values at 150° C. to 400° C. than the catalyst of Comparative Example 4 containing NiV₂O₆ functionalized with H_{3-A}PO₄^{A-}. This means that it is important to preferably control and select conditions for functionalization with H_{3-A}PO₄^{A-}, such as the concentration of the H_{3-A}PO₄^{A-} precursor ((NH₄)₂HPO₄) and the calcination temperature and time of the precursor on the catalyst surface, in order to increase the number of Brønsted acid sites of cobalt vanadate or enhance the redox properties of the catalyst surface. Nevertheless, it can be seen that, among the catalysts of Examples 7 to 9, the catalyst of Example 7 containing CoV₂O₆ exhibited the highest X_{NOX} values at 300° C. or below. This means that the use of CoV₂O₆(X=1) is preferable over the use of Co₂V₂O₇ (X=2) and Co₃V₂O₈ (X=3) to realize the desirable properties of the cobalt vanadate-based catalyst surface functionalized with H_{3-A}PO₄^{A-}.

### Experimental Example 5: Analysis V of SCR Reaction Performance

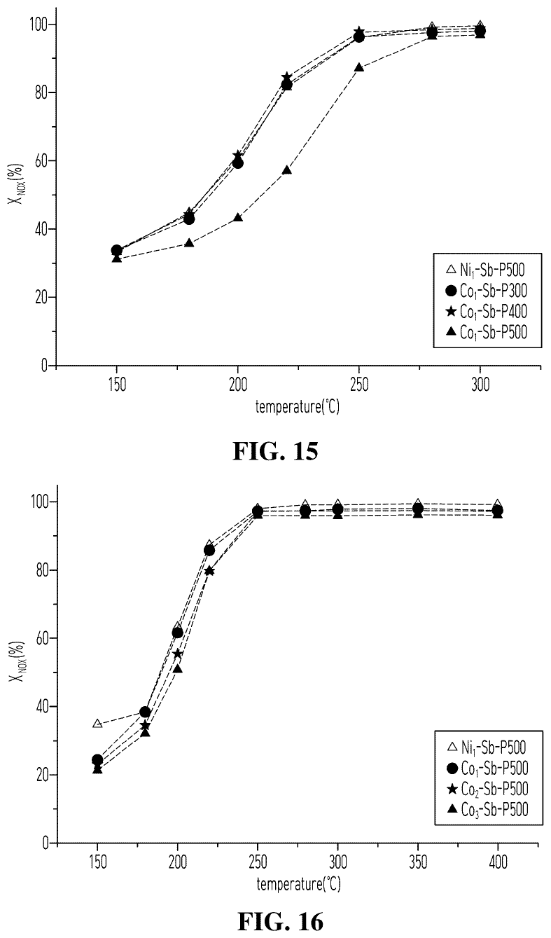

The SCR reaction performance of the catalysts of Comparative Example 4 and Examples 9 to 11 functionalized with H_{3-A}PO₄^{A-} and containing the Sb₂O₅ promoter was measured in the absence of SO₂. Specifically, the performance of the above-described catalysts was measured in the presence of a reactive fluid containing 800 ppm NO_{X}, 800 ppm NH₃, 3 vol % O₂, 6 vol % H₂O, and the inert gas N₂ at a space velocity of 60,000 hr⁻¹, and the results of measuring the nitrogen oxide conversion (NO_{X} conversion, X_{NOX}) are shown in FIG. 15. All the catalysts exhibited 100% N₂ selectivity in the temperature range of 150° C. to 400° C. Referring to FIG. 15, it can be seen that the catalysts of Examples 10 to 11 of the present disclosure containing CoV₂O₆ functionalized with H_{3-A}PO₄^{A-} at 300° C. or 400° C. and the catalyst of Comparative Example 4 containing NiV₂O₆ functionalized with H_{3-A}PO₄^{A-} at 500° C. exhibited similar X_{NOX} values at 150° C. to 400° C. This means that it is important to preferably select conditions for functionalization with H_{3-A}PO₄^{A-}, such as the temperature at which the H_{3-A}PO₄^{A-} precursor ((NH₄)₂HPO₄) on the catalyst surface is calcined, in order to increase the number of Brønsted acid sites of cobalt vanadate or enhance the redox properties of the catalyst surface.

### Experimental Example 6: Analysis VI of SCR Reaction Performance

The SCR reaction performance of the catalysts of Comparative Example 4 and Examples 7 to 9 functionalized with H_{3-A}PO₄^{A-} and containing the Sb₂O₅ promoter was measured in the presence of SO₂. Specifically, the performance of the above-described catalysts was measured in the presence of a reactive fluid containing 800 ppm NO_{X}, 800 ppm NH₃, 500 ppm SO₂, 3 vol % O₂, 6 vol % H₂O, and the inert gas N₂ at a space velocity of 60,000 hr⁻¹, and the results of measuring the nitrogen oxide conversion (NO_{X} conversion, X_{NOX}) are shown in FIG. 16. All the catalysts exhibited 100% N₂ selectivity in the temperature range of 150° C. to 400° C. Referring to FIG. 16, it can be seen that the catalysts of Examples 8 to 9 of the present disclosure, which contain cobalt vanadate (Co_{X}V₂O_{X+5}) functionalized with H_{3-A}PO₄^{A-}, exhibited smaller X_{NOX} values at 250° C. or below compared to the catalyst of Comparative Example 4, which contains NiV₂O₆ functionalized with H_{3-A}PO₄^{A-}. This means that it is important to preferably control and select conditions for functionalization with H_{3-A}PO₄^{A-}, such as the concentration of the H_{3-A}PO₄^{A-} precursor ((NH₄)₂HPO₄) and the calcination temperature and time of the precursor on the catalyst surface, in order to improve the SO₂ resistance of cobalt vanadate. Nevertheless, it can be seen that, among the catalysts of Examples 7 to 9, the catalyst of Example 7 containing CoV₂O₆ exhibited the highest X_{NOX} value at 250° C. or below, and exhibited X_{NOX} values similar to that of Comparative Example 4 at 150° C. to 400° C. This implies that the use of CoV₂O₆ (X=1) is preferable over the use of Co₂V₂O₇ (X=2) and Co₃V₂O₈ (X=3) to realize the desirable SO₂ resistance of the cobalt vanadate-based catalyst surface functionalized with H_{3-A}PO₄^{A-}.

### Experimental Example 7: Analysis VII of SCR Reaction Performance

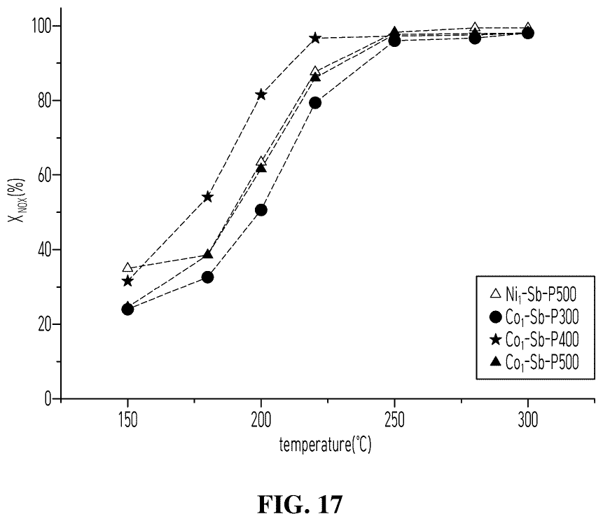

The SCR reaction performance of the catalysts of Comparative Example 4 and Examples 9 to 11 functionalized with H_{3-A}PO₄^{A-} and containing the Sb₂O₅ promoter was measured in the presence of SO₂. Specifically, the performance of the above-described catalysts was measured in the presence of a reactive fluid containing 800 ppm NO_{X}, 800 ppm NH₃, 500 ppm SO₂, 3 vol % O₂, 6 vol % H₂O, and the inert gas N₂ at a space velocity of 60,000 hr⁻¹, and the results of measuring the nitrogen oxide conversion (NO_{X} conversion, X_{NOX}) are shown in FIG. 17. All the catalysts exhibited 100% N₂ selectivity in the temperature range of 150° C. to 400° C. Referring to FIG. 17, it can be seen that the catalysts of Examples 10 to 9 of the present disclosure, which contain CoV₂O₆ functionalized with H_{3-A}PO₄^{A-} at 300° C. or 500° C., exhibited smaller X_{NOX} values at 220° C. or below compared to the catalyst of Example 11 of the present disclosure, which contains CoV₂O₆ functionalized with H_{3-A}PO₄^{A-} at 400° C. In addition, it can be seen that the catalyst of Example 11 of the present disclosure, which contains CoV₂O₆ functionalized with H_{3-A}PO₄^{A-} at 400° C., exhibited higher X_{NOX} values at 220° C. or below compared to the catalyst of Comparative Example 4, which contains NiV₂O₆ functionalized with H_{3-A}PO₄^{A-} at 500° C. This means that it is important to preferably select conditions for functionalization with H_{3-A}PO₄^{A-}, such as the temperature at which the H_{3-A}PO₄^{A-} precursor ((NH₄)₂HPO₄) on the catalyst surface is calcined, in order to improve the SO₂ resistance of cobalt vanadate.

The above description of the present disclosure is exemplary, and those of ordinary skill in the art will appreciate that the present disclosure may be easily modified into other specific forms without departing from the technical spirit or essential characteristics of the present disclosure. Therefore, it should be understood that the exemplary embodiments described above are exemplary in all aspects and are not restrictive. For example, each component described to be of a single type may be implemented in a distributed manner. Likewise, components described to be distributed may be implemented in a combined manner.

The scope of the present disclosure is defined by the following claims. It shall be understood that all modifications and changes conceived from the meaning and scope of the claims and equivalents thereto are included in the scope of the present disclosure.

What is claimed is:

1. A catalyst for nitrogen oxide reduction, comprising:
catalytic sites comprising a manganese or cobalt vanadate represented by Formula 1 below; and
a support on which the catalytic sites are supported, wherein a part of the catalytic sites is functionalized with H_{3-A}PO₄^{A-} (A=1, 2 or 3):

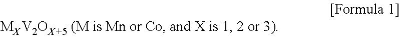

2. The catalyst of claim 1, wherein a promoter which is an oxide of a Group 15 or Group 16 element is included in the support.

3. The catalyst of claim 2, wherein the promoter is included in an amount ranging from 10⁻⁵ wt % to 50 wt % based on the weight of the support.

4. The catalyst of claim 2, wherein the Group 15 or Group 16 element is at least one selected from the group consisting of nitrogen (N), phosphorus (P), sulfur (S), arsenic (As), selenium (Se), antimony (Sb), tellurium (Te), bismuth (Bi), polonium (Po), moscovium (Mc), livermorium (Lv), and combinations thereof.

5. The catalyst of claim 1, wherein the support comprises at least one of carbon (C), Al₂O₃, MgO, ZrO₂, CeO₂, TiO₂, and SiO₂.

6. The catalyst of claim 1, wherein the manganese or cobalt vanadate represented by Formula 1 is comprised in an amount ranging from 10⁻⁴ wt % to 50 wt % based on 100 parts by weight of the support.

7. The catalyst of claim 1, wherein the support may has a porous structure.

8. A method for synthesizing a catalyst for nitrogen oxide reduction, comprising steps of:
mixing a vanadium precursor solution with a manganese or cobalt precursor solution;
adding a material constituting a support to the mixed solution;
collecting a solid from the mixed solution and calcining the solid, thereby synthesizing a catalyst in which at least one of manganese or cobalt vanadates represented by Formula 1 below is supported as catalytic sites on the support; and
functionalizing a part of a surface of the synthesized catalyst with H_{3-A}PO₄^{A-} (A=1, 2 or 3):

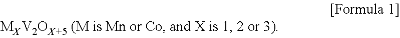

9. The method of claim 8, wherein the step of functionalizing with H_{3-A}PO₄^{A-} comprises a step of stirring the catalyst in a synthetic solvent, followed by drying,
wherein the synthetic solvent contains an organic phosphoric acid compound which is at least one of phosphoric acid (H₃PO₄), ammonium phosphite (NH₄)₃PO₄), ammonium monohydrogen phosphite (NH₄)₂HPO₄), ammonium dihydrogen phosphate (NH₄H₂PO₄), dimethyl phosphite ((CH₃O)₂HPO), diethyl phosphite ((C₂H₅O)₂HPO), trimethyl phosphite ((CH₃O)₃P), triethyl phosphite ((C₂H₅O)₃P), triisopropyl phosphite ((C₃H₇)₃P), and triphenyl phosphite ((C₆H₅O)₃P).

10. The method of claim 9, wherein a concentration of the organic phosphoric acid compound in the synthetic solvent ranges from 10⁻¹ mol L⁻¹ to 10⁵ mol L⁻¹.

11. The method of claim 9, wherein the step of stirring is performed for 0.1 hours to 24 hours.

12. The method of claim 8, wherein the step of functionalizing with H_{3-A}PO₄^{A-} is performed using a reactive gas containing oxygen (O₂).

13. The method of claim 12, wherein a concentration of oxygen (O₂) in the reactive gas ranges from 10 ppm to 10⁶ ppm.

14. The method of claim 12, wherein the step of functionalizing with H_{3-A}PO₄^{A-} is performed in a temperature range of 100° C. to 800° C. for 0.1 to 24 hours under conditions of a flow rate of 10⁻⁵ mL min⁻¹ to 10⁵ mL min⁻¹ and a pressure of 10⁻⁵ bar to 10⁵ bar.
